(19) United States
(12) Patent Application Publication
(10) Pub. No.: US 2016/0158707 A1
(43) Pub. Date: Jun. 9, 2016

(54) NOVEL MEMBRANES

(71) Applicant: BASF SE, Ludwigshafen (DE)

(72) Inventors: Martin HEIJNEN, Landsberg am Lech (DE); Martin WEBER, Maikammer (DE); Claudia STAUDT, Gau-Odernheim (DE); Marc JUNG, Singapore (SG); Natalia WIDJOJO, Singapore (SG); Peishan ZHONG, Singapore (SG); Jia Le LOW, Singapore (SG)

(73) Assignee: BASF SE, Ludwigshafen (DE)

(21) Appl. No.: 14/902,752

(22) PCT Filed: Jun. 27, 2014
(86) PCT No.: PCT/EP2014/063666

§ 371 Date: Jan. 4, 2016

(30) Foreign Application Priority Data
Jul. 4, 2013 (EP) 13175075.4

(51) Int. Cl. B01D 69/10; B01D 71/56; B01D 67/00; B01D 61/00; B01D 61/02

(52) U.S. Cl. CPC B01D 69/10; B01D 61/002; B01D 61/02; B01D 67/0088; B01D 67/0006; B01D 71/56

(57) ABSTRACT

Membrane comprising a carrier and a rejection layer, wherein said membrane is a multiple channel membrane. The rejection layer is a polyamide layer. Process for making multiple channel membranes coated with a polyamide layer.

The present invention is related to membranes comprising a carrier and a rejection layer, wherein said membrane is a multiple channel membrane.

Different types of membranes play an increasingly important role in many fields of technology. In particular, methods for treating water and for generating power rely more and more on membrane technology. In particular, Reverse Osmosis (RO) and Forward Osmosis (FO) membranes play an increasingly important role.

In many applications, such membranes are exposed to high pressures and need to endure high mechanical strain. Hence there is a need for RO and FO membranes that are mechanically robust.

WO 2012/047282 discloses thin film composite flat sheet or hollow fiber FO membranes.

Sukitpaneenit et al. (Environ. Sci. Technol. 2012, 46, 7358-7365) disclose hollow fiber thin film composite FO membranes.

Zhong et al. (Environ. Sci. Technol. 2013; in press) discloses thin film composite hollow fiber FO membranes comprising sulfonated polyphenylenesulfone as membrane substrate.

Wang et al. (Environ. Sci. Technol. 2013, in press) discloses an asymmetric multibore hollow fiber membrane for vacuum membrane distillation.

U.S. Pat. No. 6,787,216 discloses a method for manufacturing multiple channel membranes and the use thereof.

It was therefore an objective of the present invention to provide FO and RO membranes that are mechanically more robust than FO or RO membranes known in the art.

The objective has been achieved by membranes comprising a carrier and a rejection layer, wherein said membrane is a multiple channel membrane.

The concept of a membrane is generally known in the art. In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through while retaining others.

Membranes and/or the rejection layer of a membrane comprise organic polymers, hereinafter referred to as polymers, as the main components. A polymer shall be considered the main component of a membrane if it is comprised in said membrane or in the separation layer of said membrane in an amount of at least 50% by weight, preferably at least 60%, more preferably at least 70%, even more preferably at least 80% and particularly preferably at least 90% by weight.

Membranes according to the invention comprise a carrier that can also be referred to as a “support”, “support layer”, “support membrane”, “carrier membrane” or “scaffold layer”.

Suitable carriers normally have an average pore diameter of 0.5 nm to 100 nm, preferably 1 to 40 nm, more preferably 5 to 20 nm.

In one preferred embodiment, suitable carriers are by themselves suitable for use as ultrafiltration (U F), microfiltration (MF) and/or nanofiltration (NF) membranes, preferably as UF membranes.

In one embodiment, suitable carriers are carrier membranes based on inorganic materials like ceramic materials. Examples of inorganic materials are clays, silicates, silicon carbide, aluminium oxide, zirconium oxide or graphite. Such carrier membranes made of inorganic materials are normally made by applying pressure or by sintering of finely ground powder. Membranes made of inorganic materials may be composite carrier membranes comprising two, three or more layers. In one embodiment, membranes made from inorganic materials comprise a macroporous support layer, optionally an intermediate layer and a layer with an average pore diameter of 0.2 nm to 100 nm, preferably 1 to 40 nm, more preferably 5 to 20 nm.

In a preferred embodiment, carriers comprise as the main component an organic polymer like a polyarylene ether, polysulfone (PSU), polyethersulfones (PESU), polyphenylenesulfone (PPSU), polyamides (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PANPVC), PAN-methallyl sulfonate copolymer, Poly(dimethylphenylene oxide) (PPO), Polycarbonate, Polyester, Polytetrafluroethylene (PTFE), Poly(vinylidene fluoride) (PVDF), Polystyrene, Polypropylene (PP), Polyelectrolyte complexes, Poly(methyl methacrylate)

PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof.

In one embodiment, carriers can comprise sulfonated polymers like sulfonated polysulfones, polyethersulfones or polyphenylenesulfones.

In one embodiment of the invention, carriers comprise sulfonated polymers as they are for example described as polymer P1 in WO 2012/146629, p. 4, In. 14 to p. 14, In 25.

Preferably carriers comprise as the main component polysulfone, polyethersulfone, PVDF, polyimide, polyamidimide, crosslinked polyimides, polyimide urethanes, Cellulose acetate or mixtures thereof.

In one embodiment, carriers comprise further additives like polyvinylpyrrolidones (PVP), polyethylene glycols (PEG), amphiphilic block copolymers or triblock copolymers like PEG- PPO (polypropyleneoxide)-PEG.

In a preferred embodiment, carriers comprise as major components polysulfones or polyethersulfone in combination with further additives like polyvinylpyrrolidone.

In one preferred embodiment, carriers comprise 80 to 50% by weight of polyethersulfone and 20 to 50%by weight of polyvinylpyrrolidone.

In another embodiment, carriers comprise 99 to 80% by weight of polyethersulfone and 1 to 20% by weight of polyvinylpyrrolidone.

In one preferred embodiment, carriers comprise 99.9 to 50% by weight of a combination of polyethersulfone and 0.1 to 50% by weight of polyvinylpyrrolidone. In another embodiment carriers comprise 95 to 80% by weight of and 5 to 15% by weight of polyvinylpyrrolidone.

Carriers may comprise particles in the nanometer size range such as zeolites to increase the membrane porosity and/or hydrophilicity. This can for example be achieved by including such nano particles in the dope solution for the preparation of said support layer.

Normally, suitable carriers are in the form of a multiple channel (multibore) membrane, as described below in more detail. Suitable carriers can for example be obtained using processes as disclosed in U.S. Pat. No. 6,787,216 B1, col. 2, In. 57 to col. 5, In. 58.

Membranes according to the invention comprise a rejection layer that can also be referred to as a “separating layer”.

Said rejection layer can for example comprise polyamide or cellulose acetate as the main component, preferably polyamide.

Said rejection layer can for example have a thickness of 0.01 to 1 μm, preferably 0.03 to 0.5 μm, more preferably 0.05 to 0.3 μm and especially 0.15 to 0.2 μm.

In a preferred embodiment, rejection layers are obtained in a condensation of a polyamine and a polyfunctional acyl halide. Said separation layer can for example be obtained in an interfacial polymerization process. Preparation methods of such rejection layers are principally known and for example described by R. J. Petersen in Journal of Membrane Science 83 (1993) 81-150 or WO 2012/146629, p. 16, In. 14 to p. 21, In. 17.

A polyamine monomer in terms of the present invention is a compound having at least two amine groups (preferably two or three amine groups). The polyamine monomer has typically at least two amine groups selected from primary or secondary amine groups. Preferably a polyamine monomer having at least two primary amine groups is employed in the inventive method.

Suitable polyamine monomers can have primary or secondary amino groups and can be aromatic (e. g. a diaminobenzene, a triaminobenzene, m-phenylenediamine, pphenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e. g.

ethylenediamine, propylenediamine, piperazine, and tris(2-diaminoethyl)amine), cyclohexane triamine, cyclohexane diamine, piperazine and bi-piperidine.

Preferably, the polyamine monomer is an aromatic polyamine monomer comprising at least two amine groups, wherein the amine groups are directly attached to an aromatic ring. Typically the aromatic ring is an aromatic ring system comprising less than three aromatic rings, preferably the aromatic ring is phenyl. Preferably the at least one polyamine monomer is selected from phenylenediamine. Preferably the at least one polyamine monomer is meta-phenylene diamine (MPD).

A polyacylhalide monomer in terms of the present invention is a compound having at least two acyl halide (also known as an acid halide) groups, wherein an acyl halide group is derived from a carboxylic acid group by replacing a hydroxyl group with a halide group. The halide may be selected from fluorine, chlorine, bromine or iodine. Preferably the polyacylhalide monomer is a polyacylchloride.

Preferably an aromatic polyacylhalide comprising at least two acyl halide groups (preferably two or three acyl halide groups) is employed in the inventive method, wherein the acyl halide groups are directly attached to an aromatic ring. Typically the aromatic ring is an aromatic ring system comprising less than three aromatic rings. In particular the aromatic ring is phenyl, biphenyl, naphthyl, preferably phenyl. Preferably said at least one polyacylhalide is selected from acyl halides based on aromatic polycarboxylic acids, e.g. phthalic acid, isophthalic acid (meta-phthalic acid), terephthalic acid (paraphthalic acid). Preferably said at least one polyacylhalide is selected from trimellitic acid chloride, phthaloyl chloride (1,2-benzenedicarbonyl chloride), isophthaloyl chloride (1,3-benzenedicarbonyl chloride), terephthaloyl chloride (TCL, 1,4-benzenedicarbonyl chloride), and trimesoyl chloride (TMC, 1,3,5-benzene-tri-carbonyl-trichloride).

In one embodiment of the invention, the rejection layer and optionally other layers of the membrane contain particles in the nanometer size rage (herein referred to as “nanoparticles”) . Suitable nanoparticles normally have an average particle size of 1 to 1000 nm, preferably 2 to 100 nm, determined by dynamic light scattering. Suitable nanoparticles can for example be zeolites, silica, silicates or aluminium oxide. Examples of suitable nanoparticles include Aluminite, Alunite, Ammonia Alum, Altauxite, Apjohnite, Basaluminite, Batavite, Bauxite, Beideilite, Boehmite, Cadwaladerite, Cardenite, Chalcoalumite, Chiolite, Chloraluminite, Cryolite, Dawsonite, Diaspore, Dickite, Gearksutite, Gibbsite, Hailoysite, Hydrobasaluminite, Hydrocalumite, Hydrotalcite, Illite, Kalinite, Kaolinite, Mellite, Montmoriilonite, Natroalunite, Nontronite, Pachnolite, Prehnite, Prosopite, Ralstonite, Ransomite, Saponite, Thomsenolite, Weberite, Woodhouseite, and Zincaluminit, kehoeite, pahasapaite and tiptopite; and the silicates: hsianghualite, lovdarite, viseite, partheite, prehnite, roggianite, apophyllite, gyrolite, maricopaite, okenite, tacharanite and tobermorite.

Nanoparticles may also include a metallic species such as gold, silver, copper, zinc, titanium, iron, aluminum, zirconium, indium, tin, magnesium, or calcium or an alloy thereof or an oxide thereof or a mixture thereof. They can also be a nonmetallic species such as Si₃N₄, SiC, BN, B₄C, or TIC or an alloy thereof or a mixture thereof. They can be a carbon-based species such as graphite, carbon glass, a carbon cluster of at least C˜, buckminsterfullerene, a higher fullerene, a carbon nanotube like single wall, double wall or multiwall carbon nanotubes, a carbon nanoparticle, or a mixture thereof.

In yet another embodiment the rejection layer and optionally other layers of the membrane contain zeolites, zeolite precursors, amorphous aluminosilicates or metal organic frame works (MOFs) any preferred MOFs. Preferred zeolites include zeolite LTA, RHO, PAU, and KFI. LTA is especially preferred.

In another embodiment, the nanoparticles are functionalized on the surface, and comprise for example amine functional groups on the surface that can be covalently bound to polyamide layer to reduce or eliminate leaching.

Preferably, the nanoparticles comprised in the membrane have a polydispersity of less than 3.

In another embodiment of the invention the rejection layer of the membrane contains a further additive increasing the permeability of the RO or FO membrane. Said further additive can for example be a metal salt of a beta-diketonate compound, in particular an acetoacetonate and/or an at least partially fluorinated beta-diketonate compound.

In one preferred embodiment, membranes according to the invention comprise a carrier comprising polyethersulfone as main component, a rejection layer comprising polyamide as main component and optionally a protective layer comprising polyvinylalcohol as the main component.

Optionally, membranes according to the invention can comprise a protective layer with a thickness of 5 to 500 nm, preferably 10 to 300 nm. Said protective layer can for example comprise polyvinylalcohol (PVA) as the main component. In one embodiment, the protective layer comprises a halamine like chloramine.

Multiple channel membranes, also referred to as multibore membranes, comprise more than one longitudinal channels also referred to simply as “channels”.

In one embodiment when the carrier is a carrier membrane based on inorganic material like a ceramic material, the number of channels is normally larger than 50 and typically 100 to 200.

In a preferred embodiment when the carrier is a carrier membrane comprising an organic polymer as the main component, the number of channels is typically 2 to 19 longitudinal channels. In one embodiment, multiple channel carrier membranes comprise two or three channels. In another embodiment, multiple channel carrier membranes comprise 5 to 9 channels. In one preferred embodiment, multiple channel carrier membranes comprise seven channels.

In another embodiment the number of channels is 20 to 100.

The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter.

In some cases, the actual form of such channels may deviate from the idealized circular, ellipsoid or rectangular form.

Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm.

For channels with an essentially rectangular shape, these channels can be arranged in a row.

For channels with an essentially circular shape, these channels are in a preferred embodiment arranged such that a central channel is surrounded by the other channels. In one preferred embodiment, a membrane comprises one central channel and for example four, six or 18 further channels arranged cyclically around the central channel.

The wall thickness in such multiple channel membranes is normally from 0.02 to 1 mm at the thinnest position, preferably 30 to 500 μm, more preferably 100 to 300 μm.

Normally, the membranes according to the invention and carrier membranes have an essentially circular, ellipsoid or rectangular diameter. Preferably, membranes according to the invention are essentially circular. In one preferred embodiment, membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm. In another preferred embodiment, membranes according to the invention have a diameter (for essentially circular diameters), smaller diameter (for essentially ellipsoid diameters) or smaller feed size (for essentially rectangular diameters) of 2 to 4 mm.

Normally the rejection layer is located on the inside of each channel of said multiple channel carrier membrane.

Membranes according to the invention can be prepared by coating a multiple channel carrier like a UF or MF carrier membrane with a rejection layer, preferably a polyamide layer.

In one embodiment, membranes according to the invention are prepared by coating a multiple channel UF or MF carrier membrane with a polyamide rejection layer using an interfacial polymerization process.

In one embodiment, membranes according to the invention are prepared by coating a multiple channel UF or MF carrier membrane with a polyamide layer in an interfacial polymerization process using at least one polyamine and at least one polyfunctional acyl halide. Suitable polyamines and polyfunctional acyl halides are for example those named above.

Suitable reaction conditions for preparing polyamide rejection layers are principally known and for example described by R. J. Petersen in Journal of Membrane Science 83 (1993) 81-150.

In one embodiment, processes according to the invention comprise the following steps:
a) providing a multiple channel membrane carrier
b) bringing the carrier into contact with a composition A1 comprising at least one polyamine monomer having at least two amine groups and at least one solvent S1;
c) bringing the carrier into contact with a composition A2 comprising at least one polyacylhalide monomer having at least two acyl halide groups and at least one solvent S2 to form a film layer (F) onto the carrier.

The above described method provides a reliable and easy method for preparation of membranes according to the invention, wherein the obtained membranes exhibit supenor properties in FO or RO applications, in particular improved water flux and sufficient or improved salt leakage and improved mechanical stability.

Steps b) and c) of the present invention are directed to bringing the carrier into contact with a composition A1 comprising at least one polyamine monomer and with a composition A2 comprising at least one polyacylhalide monomer to form a film layer (F) onto the carrier, wherein a composite membrane is obtained.

Preferably the steps b) and c) of the inventive method, in which the polyamide film layer (F) is formed, is carried out by so called interfacial polymerization. Interfacial polymerization can form an ultrathin active layer exhibiting high water flux. The interfacial polymerization reaction generally takes place very fast on the organic side, and produces an essentially defect-free ultrathin film near the interface. As a result, the membrane production cost will be greatly reduced.

A polyamine monomer in terms of the present invention is a compound having at least two amine groups (preferably two or three amine groups). The polyamine monomer has typically at least two amine groups selected from primary or secondary amine groups. Preferably a polyamine monomer having at least two primary amine groups is employed in the inventive method.

Suitable polyamine monomers can have primary or secondary amino groups and can be aromatic (e. g. a diaminobenzene, a triaminobenzene, m-phenylenediamine, pphenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e. g. ethylenediamine, propylenediamine, piperazine, and tris(2-diaminoethyl)amine), cyclohexane triamine, cyclohexane diamine, piperazine and bi-piperidine.

Preferably, the polyamine monomer is an aromatic polyamine monomer comprising at least two amine groups, wherein the amine groups are directly attached to an aromatic ring. Typically the aromatic ring is an aromatic ring system comprising less than three aromatic rings, preferably the aromatic ring is phenyl. Preferably the at least one polyamine monomer is selected from phenylenediamine. Preferably at least one polyamine monomer is meta-phenylene diamine (MPD).

The at least one solvent 51 is preferably a polar solvent. Preferably, the at least one solvent 51 is selected from water and mixtures of water with at least one aliphatic C₁C₆ alcohol. Preferably an aqueous solution of polyamine monomer is used according to the present invention, wherein the aqueous solvent comprises at least 50 wt %, preferably at least 70 wt %, preferably at least 90 wt %, more preferably at least 99 wt % water.

In a preferred embodiment the composition A1 comprises from 0.5 to 5 wt % of at least one polyamine monomer selected from the group consisting of phenylenediamine, phenylenetriamine, cyclohexane triamine, cyclohexane diamine, piperazine, and bipiperidine and at least one solvent S1 comprising at least 50 wt % water.

A polyacylhalide monomer in terms of the present invention is a compound having at least two acyl halide (also known as an acid halide) groups, wherein an acyl halide group is derived from a carboxylic acid group by replacing a hydroxyl group with a halide group. The halide may be selected from fluorine, chlorine, bromine or iodine. Preferably the polyacylhalide monomer is a polyacylchloride.

Preferably an aromatic polyacylhalide comprising at least two acyl halide groups (preferably two or three acyl halide groups) is employed in the inventive method, wherein the acyl halide groups are directly attached to an aromatic ring. Typically the aromatic ring is an aromatic ring system comprising less than three aromatic rings. In particular the aromatic ring is phenyl, biphenyl, naphthyl, preferably phenyl. Preferably the at least one polyacylhalide is selected from acyl halides based on aromatic polycarboxylic acids, e.g. phthalic acid, isophthalic acid (meta-phthalic acid), terephthalic acid (paraphthalic acid). Preferably the at least one polyacylhalide is selected from trimellitic acid chloride, phthaloyl chloride (1,2-benzenedicarbonyl chloride), isophthaloyl chloride (1,3benzenedicarbonyl chloride), terephthaloyl chloride (TCL, 1,4-benzenedicarbonyl chloride), and trimesoyl chloride (TMC, 1,3,5-benzene-tri-carbonyl-trichloride).

The at least one solvent S2 is preferably a hydrocarbon solvent. Preferably the at least one solvent S2 is selected from the group consisting of C₁-C₁₂ alkane, C₆-C₁₂ cycloalkane, isoparaffinic liquid, C₆C₁₂ arylene (e.g. benzene, toluene). Preferably, the al least solvent S2 is selected from the group consisting of hexane, cyclohexane, heptane and benzene. More preferably n-hexane is used as solvent S2.

In a preferred embodiment the composition A2 comprises from 0.01 to 4 wt % of at least one polyacylhalide monomers selected from the group consisting of phthaloyl chloride (1,2-benzenedicarbonyl chloride), isophthaloyl chloride (1,3-benzenedicarbonyl chloride), terephthaloyl chloride (TCL, 1,4-benzenedicarbonyl chloride), and trimesoyl chloride (TMC, 1,3,5-benzene-tri-carbonyl-trichloride) and at least one solvent S2, preferably at least one hydrocarbon solvent S2.

Compositions A1 and A2 may further comprise additional components as they are customary in such compositions like surfactants, stabilizers and especially sodium dodecyl sulfate (SDS), potassium dodecyl sulfate (PDS), sodium dodecyl benzyl sulfonate (SDBS) and the family of alkyl sulfate surfactants, preferably anionic surfactants, stabilizers, triethanolamine (TEA), camphorsulfonic acid, dimethylsulfoxide (DMSO),

In particular the invention is directed to a method for the preparation of a composite membrane as described above, wherein bringing the carrier into contact with a composition A1 and/or A2 in steps b) and/or c) is effected by immersing the carrier in the composition A1 and/or composition A2 or preferably by conducting a flux of composition A1 and/or composition A2 through the carrier.

Preferably the remaining composition A1 and/or A2 on the carrier after step b) and/or c) are wiped or washed out after impregnation. Typically, the contacting time of the carrier in the composition A1 is in the range of 0.1 to 30 minutes (min). Typically, the contacting time of the carrier in the composition A2 is in the range of 5 to 240 seconds (s).

In the inventive method as mentioned above the carrier and/or the composite membrane can optionally be treated in a conditioning step after the step c), wherein conditioning steps can be selected from cleaning, washing, drying and cross-linking. Preferably, after step c) the composite membrane is dried (e.g. in air) at a temperature in the range of 30 to 150 ° C., preferably at 50 to 100° C., preferably at 50 to 70° C. and/or washed in solvents such as ethanol, isopropanol. Typically the composite membrane is dried for 10 s to 30 min and washed for 1 to 240 min.

The obtained composite membrane is typically washed and kept in water prior to use.

Another aspect of the invention are membrane elements comprising a membranes according to the invention.

A “membrane element”, herein also referred to as a “filtration element”, shall be understood to mean a membrane arrangement of at least one single membrane body. A filtration element can either be directly used as a filtration module or be included in a membrane module. A membrane module, herein also referred to as a filtration module, comprises at least one filtration element. A filtration module normally is a ready to use part that in addition to a filtration element comprises further components required to use the filtration module in the desired application, such as a module housing and the connectors. A filtration module shall thus be understood to mean a single unit which can be installed in a membrane system or in a membrane treatment plant. A membrane system herein also referred to as a filtration system is an arrangement of more than one filtration module that are connected to each other. A filtration system is implemented in a membrane treatment plant.

In many cases, filtration elements comprise more than one membrane arrangement and may further comprise more components like an element housing, one or more bypass tubes, one or more baffle plates, one or more perforated inner tubes or one or more filtrate collection tube.

Another aspect of the invention are membrane modules comprising membranes or membrane elements according to the invention.

Another aspect of the invention are filtration systems comprising membranes or membrane elements according to the invention.

Hereinafter, when reference is made to the use of “membranes” for certain applications, this shall include the use of the membranes as well as filtration elements, membrane modules and filtration systems comprising such membranes and/or membrane modules.

Membranes according to the invention are useful as forward osmosis (FO) or reverse osmosis (RO) membranes.

RO membranes are normally suitable for removing molecules and ions, in particular monovalent ions. Typically, RO membranes are separating mixtures based on a solution/diffusion mechanism.

FO membranes are for example suitable for treatment of seawater, brackish water, sewage or sludge streams. Thereby pure water is removed from those streams through a FO membrane into a so called draw solution on the back side of the membrane having a high osmotic pressure. Typically, FO type membranes, similar as RO membranes are separating liquid mixtures via a solution diffusion mechanism, where only water can pass the membrane whereas monovalent ions and larger components are rejected.

Membranes according to the invention are easy and economical to make and have very good properties with respect to their rejection properties, flux, fouling, biofouling, lifetime, durability and mechanical durability, easy to clean, high resistance towards chemicals like oxidative agents, acids, bases, reductive agents. In particular, membranes according to the invention have high tensile strengths, low break rates. In particular, membranes according to the invention can withstand high numbers of backwash cycles or mechanical cleaning due to its high mechanical strength.

Membranes according to the invention are suitable for the desalination of sea water or brackish water.

Membranes according to the invention, are particularly suitable for the desalination of water with a particularly high salt content of for example 3 to 8% by weight. For example membranes according to the invention are suitable for the desalination of water from mining and oil/gas production and fracking processes, to obtain a higher yield in these applications.

Different types of membrane according to the invention can also be used together in hybrid systems combining for example RO and FO membranes, RO and UF membranes, RO and NF membranes, RO and NF and UF membranes, NF and UF membranes.

Membranes according to the invention can be used in food processing, for example for concentrating, desalting or dewatering food liquids (such as fruit juices), for the production of whey protein powders and for the concentration of milk, the UF permeate from making of whey powder, which contains lactose, can be concentrated by RO, wine processing, providing water for car washing, making maple syrup, during electrochemical production of hydrogen to prevent formation of minerals on electrode surface, for supplying water to reef aquaria.

Membranes according to the invention can be used for rehabilitation of mines, homogeneous catalyst recovery, desalting reaction processes.

Membranes according to the invention can further be used for power generation, for example via pressure retarded osmosis (PRO). The concept of PRO is generally known in the art and is for example disclosed in Environ. Sci. Technol. 45 (2011), 4360-4369. PRO exploits the osmotic pressure difference that develops when a semipermeable membrane separates two solutions of different concentrations. As a result of the osmotic pressure difference, water permeates from the dilute “feed solution” into the more concentrated “draw solution”. A hydraulic pressure less than the osmotic pressure difference is applied on the draw solution, and a hydroturbine extracts work from the expanding draw solution volume.

### EXAMPLES

### Materials

m-Phenylenediamine (MPD, >98%, Tokyo Chemical Industry Co. Ltd, Japan), trimesoyl chloride (TMC, >98%, Tokyo Chemical Industry Co. Ltd, Japan), triethylamine (TEA, >99%, Sigma Aldrich Pte. Ltd, Singapore), sodium dodecyl sulfate (SDS, >99%, Sigma Aldrich Pte. Ltd, Singapore) and n-Hexane (Fisher Scientific, US) were used to synthesize the rejection layer of thin film composite forward osmosis (TFC FO) membranes. Sodium chloride (NaCl, >99%, Sigma Aldrich Pte. Ltd, Singapore) solutions were used to test the FO performances of TFC FO membranes. Ultrapure water with a resistivity of 18.2 MΩcm was obtained from a Milli-Q ultrapure water system (Millipore Singapore Pte. Ltd) and was used throughout this invention unless otherwise specified. All reagents were used as received.

Membrane Support (Multi Bore from Inge GmbH)

Carriers used were multiple channel ultrafiltration membranes based on polyethersulfone comprising 7 longitudinal channels (one central channel and 6 cyclically arranged channels) with an average pore size of 20 nm. (Inge Multibore® Membranes 0.9 and 1.5 provided by Inge GmbH).

“Inge Multi-bore® Membranes 0.9” had an average diameter of 0.9 mm per channel and an outer membrane diameter of 4.0 mm.

“Inge Multi-bore® Membranes 1.5” had an average diameter of 1.5 mm per channel and an outer membrane diameter of 6.0 mm.

### Forward Osmosis Testing

The FO performance of TFC FO membranes were evaluated on a lab-scale circulating filtration unit. The membranes were tested under two different modes depending on the membrane orientation: (1) pressure retarded osmosis (PRO mode) where the draw solution faced against the dense selective layer and (2) FO mode where the feed water side faced against the dense selective layer. The flow rate at the lumen and shell side were kept at 0.15 L min⁻¹ and 0.30 L min⁻¹ respectively. The FO tests were performed at room temperature (23±0.5 ° C.). Ultrapure water with conductivity below 1.0 μS cm was used as feed. Concentrated NaCl solutions (0.5 M, 1.0 M, 1.5 M, 2.0 M) were used as draw solutions. The water permeation flux Jᵥ and salt flux Jₛ were determined by measuring the weight and conductivity of the feed solution at predetermined time intervals (20 min).

The water permeation flux (Jᵥ, L·m⁻²·hr⁻¹, abbreviated as LMH) is calculated from the volume change of feed or draw solution.

Jᵥ=ΔV/(AΔt) (1)

where ΔV (L) is the permeation water collected over a predetermined time Δt (hr) in the FO process duration; A is the effective membrane surface area (m²).

The salt concentration in the feed water was determined from the conductivity measurement using a calibration curve for the single salt solution. The salt leakage, salt back-diffusion from the draw solution to the feed, Js in g·m−2·hr−1 (abbreviated as gMH), is thereafter determined from the increase of the feed conductivity:

Js=Δ(CₜVₜ)/(AΔt) (2)

where Cₜ and Vₜ are the salt concentration and the volume of the feed at the end of FO tests, respectively.

### Examples 1-4

TFC FO membranes were prepared using Inge Multibore® Membrane 0.9 via the interfacial polymerization (IP) by the polycondensation reaction between MPD and TMC. The membrane module was held in a vertical position and the flow of MPD or TMC solutions were introduced into the module from bottom to top position with the flow rate of the solutions controlled by a Manostat® Carter precision pump. MPD (2 wt %) aqueous solution containing TEA (0.5 wt %) and SDS (0.15 wt %) was fed into the lumen side of the hollow fibers for 5 min. Excess MPD residual solution was removed by purging with air for 5 min using a compressed air gun. Subsequently, TMC solution (0.15 wt %) in hexane was pumped into the saturated MPD layer on the lumen side of the hollow fibers for 3 min. After that, the module was purged with air for 1 min to remove the residual solvent and reagents after the IP reaction. The TFC membranes were then heat-cured at 65° C. for 15 min and subsequently stored in ultrapure water before further use.

TABLE 1
FO Performance of membranes with different draw solution concentration
(Feed: ultrapure water)

| | | PRO Mode | | FO Mode | |
|---|---|---|---|---|---|
| | | (Active layer facing | | (Active layer facing | |
| | | draw solution) | | feed solution) | |
| | Draw | Water | Salt Reverse | | Salt Reverse |
| | solution | Flux | Flux | Water Flux | Flux |
| Example | (M) | (LMH) | (gMH) | (LMH) | (gMH) |
| 1 | 0.5 | 11.28 | 0.19 | 3.01 | 0.37 |
| 2 | 1.0 | 18.45 | 0.12 | 3.47 | 0.59 |
| 3 | 1.5 | 25.62 | 0.12 | 3.96 | 0.71 |
| 4 | 2.0 | 30.35 | 0.12 | 4.99 | 0.76 |

### Example 5-8

An additional post treatment step was carried out after the heat-curing process to improve the FO performance. The post treatment method was varied by using different solvents in the treatment of the polyamide layer as shown in table 2. Herein, the multibore membrane comprising a polyamide layer was soaked in either ethanol or isopropanol for a period of time (1 or 2 hours) to remove the remaining diamine solution. The post-treated membrane was similarly stored in ultrapure water before further use.

TABLE 2
FO Performance of membranes with different post treatment
(Feed: ultrapure water, draw solution: 2M NaCl)

| | | PRO Mode | | FO Mode | |
|---|---|---|---|---|---|
| | | (Active layer facing | | (Active layer facing | |
| | Post | draw solution) | | feed solution) | |
| | treatment | Water | Salt Reverse | Water | Salt Reverse |
| | of IP | Flux | Flux | Flux | Flux |
| Example | layer | (LMH) | (gMH) | (LMH) | (gMH) |
| 5 | Ethanol-1 | 37.85 | 0.23 | 5.28 | 1.91 |
| | hour | | | | |
| 6 | Ethanol-2 | 41.76 | 0.18 | 6.55 | 2.45 |
| | hour | | | | |
| 7 | Isopropanol- | 43.13 | 0.13 | 6.36 | 1.30 |
| | 1 hour | | | | |
| 8 | Isopropanol- | 44.10 | 0.18 | 7.63 | 2.94 |
| | 2 hour | | | | |

### Example 9 - 15

The TFC FO Hollow Fiber Membranes were prepared using the sulfonated Multi-bore® Membrane 0.9 via the Multi-layer interfacial polymerization (IP) by the polycondensation reaction between MPD and TMC. The membrane module was held in a vertical position and the flow of MPD or TMC solutions were introduced into the module from bottom to top position with the flow rate of the solutions controlled by a Manostat° Carter precision pump. MPD aqueous solution of different concentration (from 0.03 wt % to 2 wt %) containing TEA (0.5 wt %) and SDS (0.15 wt %) was fed into the lumen side of the hollow fibers for a fixed period of time (from 1 min to 5 min). Excess MPD residual solution was removed by purging with air for a fixed period of time (from 1 to 5 min) using compressed air. Subsequently, TMC solution of different concentration (from 0.05 wt % to 0.15 wt %) in hexane was pumped into the saturated MPD layer on the lumen side of the hollow fibers for a fixed period of time (from 30 s to 3 min). After that, the module was purged with air for a fixed period of time (from 20 s to 1 min) to remove the residual solvent and reagents after the IP reaction. The TFC membranes were then heat-cured at 65° C. for 15 min. After the first TFC layer was formed, MPD aqueous solution of different concentration (from 0.03 wt % to 2 wt %) containing TEA (0.5 wt %) and SDS (0.15 wt %) was again fed into the lumen side of the hollow fibers for a fixed period of time (from 1 min to 5 min). Excess MPD residual solution was removed by purging with air for a fixed period of time (from 1 to 5 min) using compressed air. Subsequently, TMC solution of different concentration (from 0.05 wt % to 0.15 wt %) in hexane was pumped into the saturated MPD layer on the lumen side of the hollow fibers for a fixed period of time (from 30 s to 3 min) to form the second layer of TFC layer. After that, the module was purged with air for a fixed period of time (from 20 s to 1 min) to remove the residual solvent and reagents after the IP reaction. The TFC membranes were then heat-cured at 65° C. for 15 min and subsequently stored in ultrapure water before further use.

TABLE 3
FO Performance of membranes using Multi-layer IP approach
(Feed: ultrapure water, draw solution: 2M NaCl)

| | | PRO Mode | | FO Mode | |
|---|---|---|---|---|---|
| | | (Active layer facing | | (Active layer facing | |
| | | draw solution) | | feed solution) | |
| | | Water Flux | Salt Reverse | Water Flux | Salt Reverse |
| Example | Conditions | (LMH) | Flux (gMH) | (LMH) | Flux (gMH) |
| 9 | Multi-layer | — | — | 4.74 ± 0.48* | 1.51 ± 0.40* |
| | TFC without | | | | |
| | Post- | | | | |
| | treatment** | | | | |
| 10 | Multi-layer | — | — | 4.30 ± 0.29* | 1.38 ± 0.74* |
| | TFC with 1 min | | | | |
| | of MPD, | | | | |
| | 30 sec of | | | | |
| | TMC dosage | | | | |
| | for second | | | | |
| | IP** | | | | |
| 11 | 0.5 wt % MDP, | — | — | 6.45 ± 0.55* | 1.11 ± 0.59* |
| | 0.05 wt % | | | | |
| | TMC*** | | | | |
| 12 | 0.15 wt % | 53.49 | 0.27 | 8.02 | 0.74 |
| | MDP, 0.05 wt | | | | |
| | % TMC*** | | | | |
| 13 | 0.15 wt % | — | — | 7.33 | 1.57 |
| | MDP, 0.05 wt | | | | |
| | % TMC | | | | |
| | (with post- | | | | |
| | treatment with | | | | |
| | IPA for 2 h)*** | | | | |
| 14 | 0.1 wt % MDP, | — | — | 9.19 | 1.48 |
| | 0.05 wt % | | | | |
| | TMC*** | | | | |
| 15 | 0.03 wt % | — | — | 10.04 ± 0.46 | 3.11 ± 0.87 |
| | MDP, 0.05 wt | | | | |
| | % TMC*** | | | | |

*Average water flux and salt reverse flux
**Concentration of MPD and TMC are 2.0 wt % and 0.15 wt % respectively unless otherwise stated
***1 min of MPD dosage, 30 sec of TMC dosage for both first and second IP

1. A membrane comprising a carrier and a rejection layer, wherein the membrane is a multiple channel membrane.

2. Membrane The membrane according to claim 1, wherein the rejection layer is a polyamide layer.

3. The membrane according to claim 1, wherein the carrier is a multiple channel UF or MF carrier membrane.

4. The membrane according to claim 1, wherein the carrier consists essentially of polyarylene ether, polysulfone (PSU), polyethersulfone (PESU), polyphenylenesulfone (PPSU), polyamide (PA), polyvinylaleohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherketone (PEK), Polyetheretherketone (PEEK), sulfonated polyetheretherketone (SPEEK), Poly(dimethylphenylene oxide) (PPO), Polycarbonate, Polyester, Polytetrafluroethylene PTFE, Poly(vinylidene fluoride) (PVDF), Polystyrene (PS), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or mixtures thereof.

5. The membrane according to claim 1, wherein the carrier consists essentially of polysulfone, polyethersulfone, polyphenylene sulfone, PVDF or cellulose acetate.

6. The membrane according to claim 1, wherein the membrane comprises 2 to 19 longitudinal channels.

7. The membrane according to claim 1, wherein the membrane comprises 7 longitudinal channels.

8. The membrane according to claim 2, wherein the polyamide rejection layer is located on the inside of each channel of the multiple channel carrier membrane.

9. The membrane according to claim 2, wherein the polyamide rejection layer has a thickness of 10 to 1000 nm.

10. The membrane according to claim 2, wherein the polyamide rejection layer and/or carrier comprises particles in the of a nanometer size range.

11. The membrane according to claim 1, further comprising a protective layer on the rejection layer.

12. The membrane according to claim 1, wherein the membrane is an FO or RO membrane.

13. A membrane module comprising at least one membrane according to claim 1.

14. A filtration system comprising at least one membrane module according to claim 13.

15. A process for making the membrane of claim 1, comprising coating a multiple channel UF or MF carrier membrane is coated with a polyamide layer.

16. The process according to claim 15, wherein the multiple channel UF or MF carrier membrane is coated with a polyamide layer using an interfacial polymerization process.

17. The process according to claim 15, wherein the multiple channel UF or MF carrier membrane is coated with a polyamide layer in an interfacial polymerization process using at least one polyamine and at least one polyfunctional acyl halide.

18. The process according to claim 15, comprising:
a) contacting the multiple channel UF or MF carrier membrane with a composition A1 comprising at least one polyamine monomer having at least two amine groups and at least one solvent S1; and
b) contacting the multiple channel UF or MF carrier membrane with a composition A2 comprising at least one polyacylhalide monomer having at least two acyl halide groups and at least one solvent S2 to form a film layer (F) on the multiple channel UF or MF carrier membrane.

19. (canceled)
